(19) United States
(12) Patent Application Publication
(10) Pub. No.: US 2026/0134596 A1
(43) Pub. Date: May 14, 2026

(54) ALBUM IMAGE TAG FOLDING AND CATEGORIZATION PREVIEW METHOD

(71) Applicant: MemoriesNet Technology Limited, HONG KONG (CN)

(72) Inventor: Peijian XU, Guangzhou (CN)

(21) Appl. No.: 19/385,106

(22) Filed: Nov. 10, 2025

(30) Foreign Application Priority Data
Nov. 12, 2024 (CN) 202411604903.0

(51) Int. Cl. G06T 11/60; G06V 10/764; G06V 20/30

(52) U.S. Cl. CPC G06T 11/60; G06V 10/764; G06V 20/30; G06T 2200/24

(57) ABSTRACT

An album image tag folding and categorization preview method, which aims to improve image management efficiency and browsing experience. The method includes key steps such as image group generation, main album collection folding and tag floating layer display, group tag information editing and display, and expansion of the main album collection and sub-tag display. A user may freely select images to generate an image group, and form a main album collection through folding and accommodating, while a tag floating layer is superimposed to intuitively present group tag information. The group tags and sub-tags are editable to provide more detailed descriptions of image content. The main album collection may be expanded to view detailed images and sub-tags. The invention supports multiple image types, offers intelligent interaction and quick search and locating functions, and improves the album management process and browsing experience.

### TECHNICAL FIELD

The present disclosure relates to the technical field of image processing and information management, and more particularly to an album image tag folding and categorization preview method to improve image management efficiency and browsing experience, as well as a terminal operation control apparatus and a non-volatile computer-readable storage medium to implement the method.

### BACKGROUND

With the rapid development of digital technology, people increasingly tend to use electronic devices to store and manage a large number of image materials, including photos, pictures, and videos, the accumulated time span of which may exceed ten years. In album applications, how to efficiently and intuitively manage and search such image materials has become an important issue. In particular, when searching for a specific image taken many years ago that carries special meaning, a user often needs to browse through many pages or use different methods to locate a related image page. Traditional album management methods generally lack intuitiveness and convenience, especially when users need to annotate, classify, or search for images, resulting in complicated operations and low efficiency.

Specifically, as the frequency of taking photos and recording videos with mobile phones increases, and as the storage capacity of mobile devices continues to expand, the number of pictures and videos stored in user albums has grown rapidly, often reaching thousands or even tens of thousands. Traditional photo management methods include album categorization, in which albums with different names are created and corresponding photos are placed under them. However, although photos can be grouped into corresponding albums, they still remain visible in the main album view, and users cannot skip them when browsing all photos. Even within a sub-album containing thousands of images, it is still difficult to quickly find a desired photo by browsing. The “Favorites” function can collect important pictures, but it essentially works the same way as album categorization, and when the number of favorite items increases, it also becomes difficult to locate a specific one quickly. Automatic recognition based on image attributes, such as detecting people or places, can identify images with clear features, but the recognition error rate remains high. For images and videos with less distinctive features, intelligent recognition often fails to locate the desired files accurately. Whether for pictures or videos, a large amount of data needs to be processed during searching and retrieval, which leads to low efficiency and high resource consumption.

### SUMMARY

To overcome the shortcomings of the prior art, an album image tag folding and categorization preview method is provided. This invention is intended to improve the management efficiency and browsing experience of album images by providing an improved method for image categorization, tag management, and preview display.

To achieve the above objectives, an album image tag folding and categorization preview method is provided, including: selecting one or more unit images in an album, and, through a preset interactive operation, aggregating the selected unit images to generate an image group; in a thumbnail window of the album, folding and accommodating the unit images belonging to the same image group in an orderly manner to form a main album collection, and a tag floating layer is superimposed over the thumbnail window, and the tag floating layer, based on an image layout of the thumbnail window, forms group tag regions that overlap and are associated one-to-one with respective main album collections at their overlapping regions; editing group tag information for the image group, such that the group tag information associated with the image group is displayed in a floating manner within the corresponding group tag region of the tag floating layer; and through a preset interactive operation, selecting the main album collection so that the unit images belonging to the same image group are orderly expanded and displayed in the thumbnail window of the album, and the tag floating layer, based on the image layout of the thumbnail window when the main album collection expands, forms unit tag regions that overlap and are associated one-to-one with respective unit images at their overlapping regions, such that the group tag information associated with the image group is displayed in a floating manner within the unit tag regions corresponding to respective unit images.

In one embodiment, a user selects one or more unit images in the album and edits unit tag information, and the edited unit tag information is correspondingly associated with and displayed in a floating manner within the unit tag regions corresponding to the respective unit images.

In one embodiment, the unit image is of any one of image types including a photograph, a picture, a video, or a screenshot.

In one embodiment, when the user selects any unit image in the thumbnail window of the album to enter a detailed viewing window of the single unit image, the tag floating layer together with its group tag information and/or unit tag information is displayed in a layered manner, deactivated, or hidden as needed; when the user returns to the thumbnail window of the album, the tag floating layer together with its group tag information and unit tag information is re-activated or displayed again.

In one embodiment, when the user selects one or more unit images in the album to edit the group tag information, if the edited group tag information already exists, the selected unit images are folded and accommodated into the existing main album collection corresponding to the existing group tag information.

In one embodiment, when the user needs to locate images with a specific tag, unit images corresponding to the tag are determined through a search based on the tag information, including: extracting all tag information and positional information of the corresponding tag regions, and establishing an index database based on the extracted information; performing data matching in the index database based on input search feature information to identify matched tag information; and based on the positional information of the tag regions corresponding to the matched tag information, determining the main album collections and/or unit images that are overlapped by and associated with the matched tag information.

In one embodiment, one or more unit images within the same main album collection are selected, and through a preset interactive operation, the selected unit images are aggregated to create a sub-group, such that the unit images of the sub-group are folded and arranged in an orderly manner to form a sub-album collection in the expanded view of the main album collection.

In one embodiment, in the expanded view of the main album collection, the tag floating layer, based on the image layout of the thumbnail window, forms sub-tag regions that overlap and are associated one-to-one with respective sub-album collections at their overlapping regions; the user selects any sub-group in the expanded view of the main album collection and edits sub-tag information, and the edited sub-tag information is correspondingly associated with and displayed in a floating manner within the sub-tag region corresponding to the sub-album collection.

In one embodiment, a terminal operation control apparatus is provided, including a processor and a memory configured to store processor-executable instructions. The processor is configured to implement any one of the methods described above.

In one embodiment, a non-volatile computer-readable storage medium storing computer program instructions is provided. When the computer program instructions are executed by the processor, the instructions cause the processor to implement any one of the methods described above.

The invention adopts the above technical solution, and has the following beneficial effects:
Improved management efficiency: Since different users have different needs, the folding of image groups and tag management allow users to easily perform personalized categorization and tagging of images according to their own requirements so as to improve management efficiency;
Enhanced browsing experience: The design of the tag floating layer and the sub-tag region enables users to intuitively view tag information of images while browsing the album, which improves the browsing experience and reduces the total number of thumbnail images displayed in the main album view;
Support for multiple image types: The method supports various image types, including photos, pictures, videos, and screenshots, making it broadly applicable and practical;
Quick search and locating function: The search function based on tag information allows users to quickly locate images with specific tags, improving search efficiency.

### BRIEF DESCRIPTION OF THE DRAWINGS

FIG. 1 is a flow diagram illustrating the album image tag folding and categorization preview method;

FIG. 2 is a schematic diagram illustrating the album image tag folding and categorization preview method;

FIG. 3 is a schematic diagram illustrating a thumbnail window, a tag floating layer and its group tag regions of an album;

FIG. 4 is a schematic diagram illustrating a thumbnail window, a tag floating layer and its sub-tag regions of an album;

FIG. 5 is a schematic diagram illustrating a thumbnail window, a tag floating layer and its unit tag regions of an album;

FIG. 6 is a schematic diagram illustrating a layered structure of a thumbnail window, a tag floating layer and its group tag regions of an album;

FIG. 7 is a schematic diagram illustrating a layered structure of a thumbnail window, a tag floating layer and its sub-tag regions of an album;

FIG. 8 is a schematic diagram illustrating a layered structure of a thumbnail window of an album, a tag floating layer and its unit tag regions; and

FIGS. 9-11 are schematic diagrams illustrating specific tag examples in some embodiments.

### DETAILED DESCRIPTION

To facilitate understanding of the present disclosure, a more detailed description of the present disclosure is provided below with reference to the accompanying drawings, in which preferred embodiments of the present disclosure are shown. However, it should be understood that the disclosure may be embodied in many different forms and should not be construed as limited to the embodiments set forth herein. The embodiments are provided so that the disclosure of the present invention may be thoroughly and fully understood.

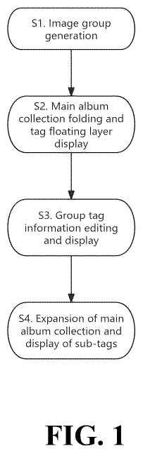

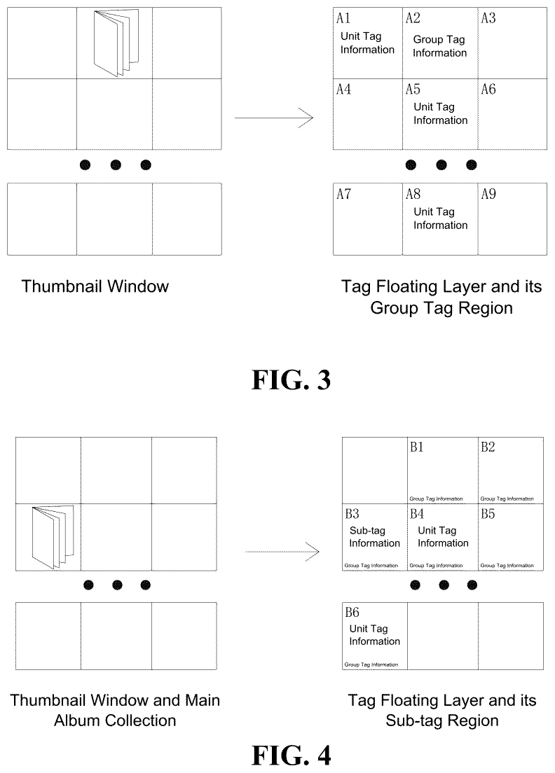

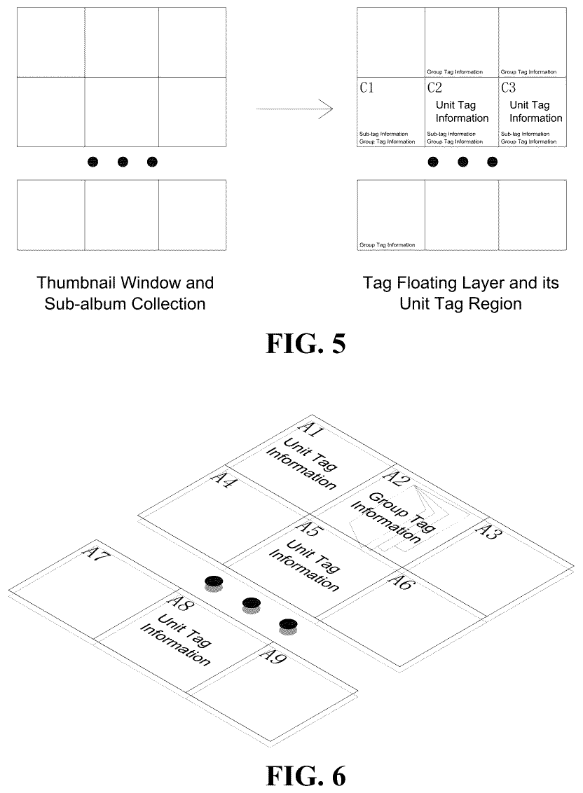

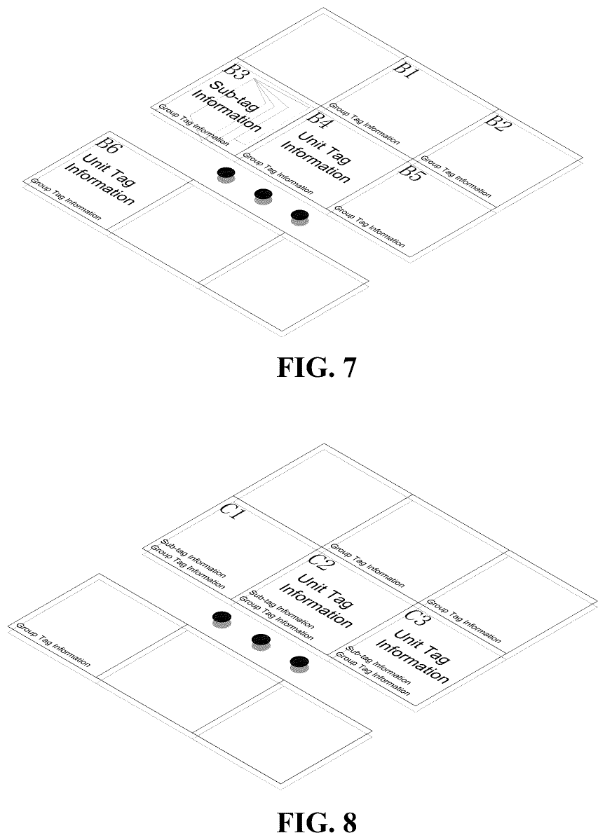

Referring to FIGS. 1 to 7, in one embodiment, an album image tag folding and categorization preview method is provided. The method allows a user to add custom tag information to a plurality of unit images stored in an album. The edited tag information may be displayed in a floating manner within corresponding tag regions of a tag floating layer, and multiple unit images having the same tag information may be categorized and grouped accordingly. This enables the user to intuitively and clearly identify the corresponding unit images and categorized collections based on tag information, facilitates quick recognition and location of desired images and videos from a large number of pictures in the album. The edited tag information does not alter the original graphical attributes of the unit images.

Specifically, in one embodiment, the album image tag folding and categorization preview method includes the following steps:

### Step S1. Image Group Generation:

Within an album, any one or more unit images are selected, and the selected unit images are aggregated to generate an image group through a preset interactive operation. Specifically, a user may freely select any one or more unit images in the album (including but not limited to photos, pictures, videos, and screenshots) and aggregate the selected unit images into an image group through a preset interactive operation such as dragging or double-clicking.

### Step S2. Main Album Collection Folding and Tag Floating Layer Display:

In the thumbnail window of the album, unit images belonging to the same image group are folded and accommodated in an orderly manner to form a main album collection. A tag floating layer is superimposed over the thumbnail window, and the tag floating layer, based on an image layout of the thumbnail window, forms group tag regions that overlap and are associated one-to-one with respective main album collections at their overlapping regions.

Specifically, first, within the thumbnail window, multiple unit images belonging to the same image group are intelligently folded and accommodated to form an orderly arranged main album collection. The arrangement of the main album collection attempts, as much as possible, not to alter the album's original layout, so as to avoid the need for users to learn and adapt to new operation habits. The folding of image groups saves display space for the thumbnail window and makes the album interface cleaner. Second, a tag floating layer is superimposed over the thumbnail window. The tag floating layer is dynamically generated and, based on the layout of the thumbnail window and the position of each main album collection, automatically forms group tag regions that overlap and are associated one-to-one with respective main album collections at their overlapping regions. The tag floating layer enables users to intuitively view the tag information of image groups without needing to open the images, thereby improving browsing efficiency. The tag floating layer is presented in a transparent state (this approach requires no change to the existing operation habits of the user and allows the user to view the underlying unit images through the transparent tag floating layer). Moreover, the superimposing structure of the tag floating layer and the thumbnail window ensures that the actual operation remains consistent with that of an existing album interface, so that additional operation habits are not required. Meanwhile, to ensure a smooth user experience, the interaction logic between the main album collection and the tag floating layer may be optimized. When a user selects or moves a main album collection via an interactive operation (such as clicking, sliding, zooming in, or zooming out, which changes the thumbnail layout of the album), the tag floating layer updates in real time, ensuring that the one-to-one correspondence between the group tag region and the main album collection remains consistently accurate.

### Step S3. Group Tag Information Editing and Display:

Through editing group tag information for an image group, the group tag information associated with the image group is displayed in a floating manner within a corresponding group tag region of the tag floating layer. Specifically, a user may edit the group tag information of the image group, and the edited group tag information is displayed in a floating manner within the corresponding group tag region, in this way, an intuitive association between the tag and the image group is realized.

Preferably, for ease of understanding of the editing and displaying of the group tag information described above, further details are provided as follows:

Editing function: The user may double-click or long-press the group tag region on the main album collection to trigger an editing mode. In the editing mode, the user may input or modify group tag information, such as “Europe Tour,” “Travel Photos,” or “Family Gathering”, to describe the content or theme of the image group.

Display logic: After the editing is completed, the group tag information is automatically displayed within the corresponding group tag region. The font size, color, and other styles of the displayed information may be system default settings or adjusted according to user preferences to ensure readability and clarity of the displayed information.

Real-time update: When the user modifies the group tag information, the system updates the display content in the tag floating layer in real time to ensure the accuracy and consistency of the information.

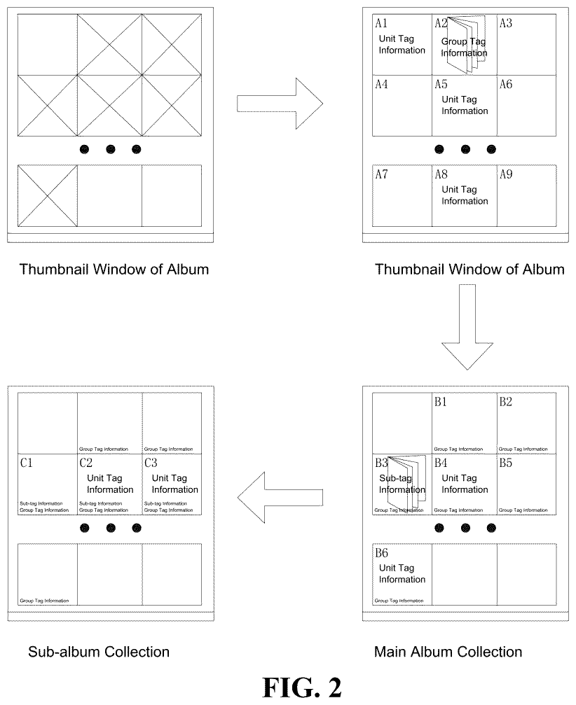

Specifically, after the user completes editing the group tag information of any main album collection, the group tag region within the tag floating layer that corresponds to that main album collection displays the group tag information. For example, with reference to FIGS. 2, 3, and 6, when several unit images are selected and folded to form a new main album collection, the tag floating layer correspondingly forms a group tag region A2 that overlaps the main album collection. The user may edit and assign the group tag information “Europe Tour” to the main album collection, so that the group tag information “Europe Tour” is displayed in a floating manner within the group tag region A2. Based on this, when the user needs to locate unit images related to the “Europe Tour,” the user may preview the album in the thumbnail window and quickly identify the corresponding main album collection by searching the tag containing the words “Europe Tour.”

### Step S4. Expansion of Main Album Collection and Display of Sub-Tags:

Through a preset interactive operation, the main album collection is selected so that the unit images belonging to the same image group are orderly expanded and displayed in the thumbnail window of the album. Meanwhile, the tag floating layer, based on the image layout of the thumbnail window when the main album collection expands, forms unit tag regions that overlap and are associated one-to-one with respective unit images at their overlapping regions, such that the group tag information associated with the image group is displayed in a floating manner within the unit tag regions corresponding to respective unit images. For example, referring to FIG. 2, the group tag information “Europe Tour” is correspondingly displayed at the lower-left corner of the unit tag regions associated with each unit image of the image group. Specifically, the user may perform a preset interactive operation (such as clicking or double-clicking) on the main album collection to trigger the expansion operation. After expansion, the unit images of the same image group are orderly arranged in the thumbnail window of the album. At the same time, the tag floating layer, based on the new image layout, forms unit tag regions above each unit image. The unit tag regions correspond one-to-one with the respective unit images and are configured to display the group tag information associated with the image group, allowing the user to intuitively and clearly recognize which image group each unit image belongs to.

Further, unit tag information editing is provided: The user may select any unit image in the album and edit unit tag information (by inputting or modifying the unit tag information). The edited unit tag information is correspondingly displayed in a floating manner within the unit tag region corresponding to the unit image. Accordingly, after the image group is expanded, the user can directly view the unit tag information floating above the unit images, so as to intuitively and quickly locate the desired unit image. Specifically, the user may add unit tag information to any one or more unit images within the same main album collection. For example, with reference to FIGS. 2-10, in different view interfaces, the tag floating layer correspondingly forms unit tag regions A1, A5, A8, B4, B6, C2, and C3, which respectively overlap the corresponding unit images. The user may edit and assign the unit tag information “Scenery,” “Portrait,” “Contract,” “Family,” “Windmill,” “Road,” and “Seaside” to the unit tag regions A1, A5, A8, B4, B6, C2, and C3, respectively, so that each piece of unit tag information is displayed in a floating manner within the corresponding unit tag region. Based on the above, when the user needs to locate unit images related to “Europe Tour,” the user may not only preview and identify the “Europe Tour” group tag in the thumbnail window of the album, but also preview the related unit tag information displayed in the expanded main album collection, so as to intuitively and efficiently locate the desired unit images.

In one embodiment, a detailed view window and tag display control function are provided: When a user selects any unit image in the thumbnail window of the album to enter a detailed view window of a single unit image, the tag floating layer and its associated group tag information, sub-tag information, and/or unit tag information may be set, as needed, to be displayed in a layered manner, or to be deactivated or hidden. When the user operates to return to the thumbnail window of the album, the tag floating layer and its associated group tag information, sub-tag information, and unit tag information are reactivated or displayed again. Specifically, in the detailed view window, the user may set the display mode of the tags as needed, such as layered display, deactivated, or hidden. When returning to the thumbnail window, the tags will be restored to their previous display state. With this approach, interference of tag information with the user's visual perception during viewing of a single unit image can be avoided, which prevents disruption of the user's detailed browsing experience. In addition, the tag floating layer and its associated group tag information, sub-tag information, and/or unit tag information may be set to deactivate or hide immediately, or with a delay. The delayed deactivating or hiding mode allows the user to briefly view the tag information before continuing to browse the unit image. The specific implementation is not limited herein and may be selected as appropriate by those skilled in the art.

In one embodiment, a group tag information reuse function is further provided: When a user selects one or more unit images in the album to edit group tag information, if the edited group tag information already exists, the selected unit images are correspondingly folded and accommodated into the existing main album collection. Specifically, if the group tag information edited by the user already exists, the system automatically incorporates the selected unit images into the existing main album collection associated with that group tag information to avoid redundant creation of duplicate tags.

In one embodiment, after multiple unit images are folded and accommodated to form an image group, the unit images within the same image group may be further categorized and grouped as needed, so that the user can browse and locate desired images more intuitively from a large number of unit images. Specifically, the user may select any one or more unit images within the same image group and perform a preset interactive operation (such as double-clicking or long pressing) to further collect the selected unit images within the expanded view of the same main album collection as a new sub-group. Accordingly, the unit images of the new sub-group are folded and arranged in an orderly manner in the expanded view of the main album collection to form a sub-album collection. At this time, within the expanded view of the main album collection, the user may select the sub-album collection through a preset interactive operation (such as clicking or double-clicking) to perform an expansion operation, so that the unit images of the sub-group are arranged in an orderly manner in the thumbnail window of the album. In addition, in the expanded view of the main album collection, the tag floating layer, based on the image layout of the thumbnail window, forms sub-tag regions that overlap and are associated one-to-one with respective sub-album collections at their overlapping regions. Furthermore, by editing sub-tag information for the sub-group, the sub-tag information associated with the sub-group is displayed in a floating manner within the corresponding sub-tag region of the tag floating layer. Specifically, referring to FIGS. 2-10, within the expanded view of the main album collection, the tag floating layer correspondingly forms a sub-tag region B3 overlapping and being associated with the sub-album collection. The user may edit the sub-tag information of the sub-album collection as “United Kingdom”, so that the sub-tag region B3 correspondingly displays the floating tag “United Kingdom”.

Similarly, when the sub-album collection expands, the tag floating layer correspondingly forms sub-tag regions that overlap and are associated with each unit image, so as to facilitate editing or displaying the sub-tag information and unit tag information associated with each unit image, thereby allowing a user to intuitively and clearly recognize the tag information of each unit image. Specifically, in an expanded view of the sub-album collection, the tag floating layer correspondingly forms unit tag regions C1, C2, and C3 that overlap and associate with the respective unit images within the same sub-album collection. The user may edit the unit tag regions C2 and C3 to assign the unit tag information “Street” and “Seaside,” respectively; in this way, the corresponding unit tag information is displayed in a floating manner within the unit tag regions C2 and C3.

Similarly, a sub-tag information reuse function is provided: if the sub-tag information edited by the user already exists, the selected unit images are correspondingly folded and accommodated into the existing sub-album collection to avoid creating duplicate tags.

In one embodiment, a group tag information search function is provided: When a user needs to locate images with a specific tag, unit images associated with the tag are determined through a search based on the tag information, including the following:

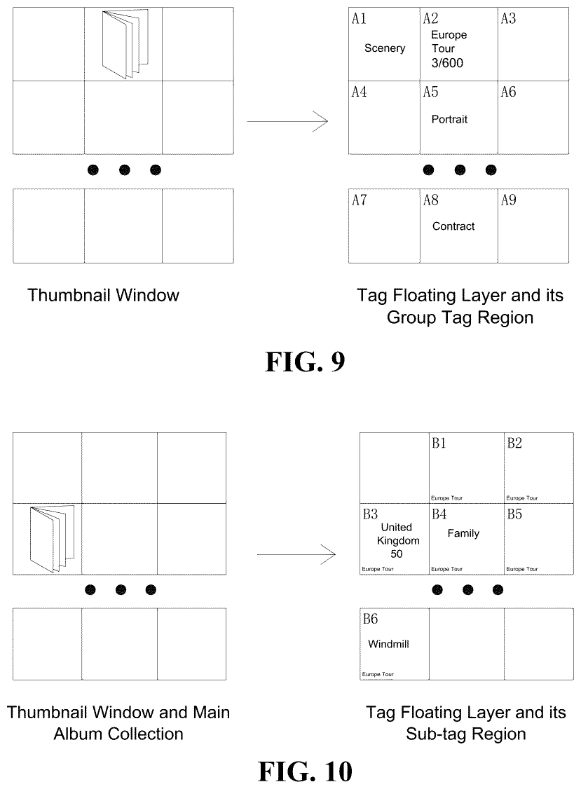

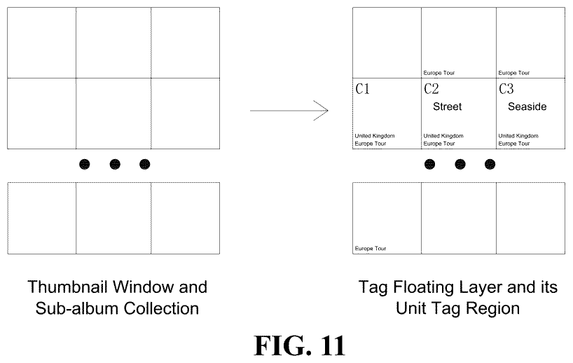

First, the system extracts all tag information and positional information of the corresponding tag regions, and aggregates the data to establish an index database. Specifically, the system extracts all tag information and the positional information of the corresponding tag regions, and establishes and maintains an index database. The index database is used to store the association relationships between tag information and unit images. For ease of understanding, referring to FIGS. 9-11, the following schematic index database is formed.

In the thumbnail window of the album, the tag floating layer correspondingly displays the group tag information and the unit tag information of other ungrouped unit images, as shown in Table 1 below:

TABLE 1

| | | | | | | | | | |
|---|---|---|---|---|---|---|---|---|---|
| Thumbnail | A1 | A2 | A3 | A4 | A5 | A6 | A7 | A8 | A9 |
| Window of Album | Region | Region | Region | Region | Region | Region | Region | Region | Region |

| | | | | |
|---|---|---|---|---|
| Group Tag | | Europe | | |
| Information | | Tour | | |
| Unit Tag | Scenery | | Portrait | Contract |
| Information | | | | |

In the expanded view of the main album collection, the tag floating layer correspondingly displays the sub-tag information, the group tag information, and the unit tag information of other unit images that are not grouped into sub-groups, as shown in Table 2:

TABLE 2

| Group Tag | Europe | Europe | Europe | Europe | Europe | Europe |
|---|---|---|---|---|---|---|
| Information | Tour | Tour | Tour | Tour | Tour | Tour |
| Expanded | B1 Region | B2 Region | B3 Region | B4 Region | B5 Region | B6 Region |
| View of Main | | | | | | |
| Album | | | | | | |
| Collection | | | | | | |
| Sub-tag | | | United | | | |
| Information | | | Kingdom | | | |
| Unit Tag | | | | Family | | Windmill |
| Information | | | | | | |

In the expanded view of the sub-album collection, the tag floating layer correspondingly displays the unit tag information of unit images belonging to the sub-group, as shown in Table 3 below:

TABLE 3

| Sub-tag | United | United | United |
|---|---|---|---|
| Information | Kingdom | Kingdom | Kingdom |
| Expanded | C1 Region | C2 Region | C3 Region |
| View of | | | |
| Sub-album | | | |
| Collection | | | |
| Unit Tag | | Street | Seaside |
| Information | | | |

Next, the system performs data matching in the index database based on the input search feature information to determine the matched tag information. Specifically, when the user needs to search for images with a specific tag, the user inputs search feature information (such as a keyword or a picture) into a search box, and a matching search is performed in the index database to identify the tag information that meets the search condition. For example, when the user inputs the keyword “Europe Tour” in the search box, the system performs a matching search in the index database and identifies the corresponding group tag information “Europe Tour.” Alternatively, when the user inputs the keyword “United Kingdom” in the search box, the system performs a matching search in the index database and identifies the corresponding sub-tag information “United Kingdom”. Alternatively, when the user inputs the keyword “Seaside” in the search box, the system performs a matching search in the index database and identifies the corresponding unit tag information “Seaside.”

Further, based on the positional information of the tag regions corresponding to the matched tag information, the system determines the main album collections, sub-album collections, and/or unit images that are overlapped by and associated with the matched tag information. Specifically, based on the matched tag information, the system determines the associated main album collections, sub-album collections, and/or unit images, and directly locates the positions of the corresponding main album collections, sub-album collections, and/or unit images within the album. If there are multiple sub-album collections and/or unit images associated with the same tag, an operation button such as “Next” may be provided to allow the user to jump and locate the next corresponding image by pressing the button. Alternatively, the multiple sub-album collections and/or unit images with the same tag may be arranged in a search result list. For example, based on the matched tag information “Europe Tour,” the system determines the associated group tag region A2, the sub-tag regions b1-b6, and the corresponding unit images, which may then be displayed as highlighted prompts within the thumbnail window or extracted and arranged in a search result list. A person skilled in the art may select an appropriate implementation as needed, which is not specifically limited herein.

Based on the foregoing group tag information reuse function, the user can quickly search for and locate a specific image or image group by inputting a tag keyword.

In summary, the user first selects images through the album application and creates an image group, and then views the folded main album collection in the thumbnail window. Next, the user may edit group tag information to be displayed in a floating manner within the group tag region of the tag floating layer, and expand the main album collection as needed to view detailed images and sub-tag information. In addition, the user may also perform various operations such as editing and searching tag information of unit images. Throughout the entire process, the system ensures a smooth and efficient user experience with intelligent interactive logic.

In one embodiment, to facilitate a more intuitive understanding of the quantity information contained in the main album collections and the sub-album collections, a person skilled in the art may display the quantity information correspondingly in the group tag regions and the sub-tag regions. For example, when the group tag region displays “3/600”, it indicates that the main album collection corresponding to that group tag region includes 600 unit images and three sub-album collections. Similarly, when the sub-tag region displays “50”, it indicates that the sub-album collection corresponding to that sub-tag region includes 50 unit images.

In one embodiment, a terminal operation control apparatus is provided. The terminal operation control apparatus specifically includes: a processor, a memory, a display module and an input module. The processor is configured to execute instructions stored in the memory so as to implement the steps of the album image tag folding and categorization preview method above. The memory is configured to store processor-executable instructions, tag information, unit image data, and other necessary data. The memory may be any form of storage device such as a RAM, a ROM, a flash memory, or a hard disk drive. The display module is configured to display user interface elements such as the thumbnail window, tag floating layer, and search results. And the input module is configured to receive user input operations such as clicking, long pressing, and swiping, to trigger functions such as tag information editing and searching.

When a user selects a unit image through the input module and triggers the tag editing function, the processor reads the relevant instructions and data stored in the memory and performs operations to edit and display the tag information.

When the user inputs search feature information to perform a search, the processor searches and matches tag information satisfying the conditions in the memory, and then updates the user interface on the display module to present the search results.

The processor is further configured to control the display and hiding of the tag floating layer according to user operations, such as entering a detailed viewing mode or returning to the thumbnail window.

In one embodiment, a non-volatile computer-readable storage medium is further provided. The storage medium stores computer program instructions to implement the above-described method. When the computer program instructions are executed by the processor, the instructions cause the processor to perform tasks including tag information editing, display, searching, and user interaction. The non-volatile computer-readable storage medium may be any form of storage device, including but not limited to a USB flash drive, an SD card, a solid-state drive, or an optical disc.

The embodiments described above are merely preferred embodiments of the present invention and are not intended to limit the scope of the invention in any form. Any person of ordinary skill in the art may, without departing from the scope of the technical solution of the present invention, make various modifications, improvements, or adjustments to the provided technical content, all of which shall be regarded as equivalent embodiments of the invention. Therefore, all equivalent or corresponding modifications made based on the technical concept of the present invention shall fall within the scope of the invention.

It must be noted that as used herein and in the appended claims, the singular forms “a”, “an”, and “the” include their plural equivalents, unless the context clearly dictates otherwise.

1. An album image tag folding and categorization preview method, comprising:
selecting one or more unit images in an album, and, through a preset interactive operation, aggregating the selected unit images to generate an image group;
in a thumbnail window of the album, folding and accommodating the unit images belonging to the same image group in an orderly manner to form a main album collection, wherein a tag floating layer is superimposed over the thumbnail window, and the tag floating layer, based on an image layout of the thumbnail window, forms group tag regions that overlap and are associated one-to-one with respective main album collections at their overlapping regions;
editing group tag information for the image group, such that the group tag information associated with the image group is displayed in a floating manner within the corresponding group tag region of the tag floating layer; and
through a preset interactive operation, selecting the main album collection so that the unit images belonging to the same image group are orderly expanded and displayed in the thumbnail window of the album, and the tag floating layer, based on the image layout of the thumbnail window when the main album collection expands, forms unit tag regions that overlap and are associated one-to-one with respective unit images at their overlapping regions, such that the group tag information associated with the image group is displayed in a floating manner within the unit tag regions corresponding to respective unit images.

2. The method according to claim 1, wherein a user selects one or more unit images in the album and edits unit tag information, and the edited unit tag information is correspondingly associated with and displayed in a floating manner within the unit tag regions corresponding to the respective unit images.

3. The method according to claim 1, wherein the unit image is of any one of image types including a photograph, a picture, a video, or a screenshot.

4. The method according to claim 1, wherein when the user selects any unit image in the thumbnail window of the album to enter a detailed viewing window of the single unit image, the tag floating layer together with its group tag information and/or unit tag information is displayed in a layered manner, deactivated, or hidden as needed; when the user operates to return to the thumbnail window of the album, the tag floating layer together with its group tag information and unit tag information is re-activated or displayed again.

5. The method according to claim 1, wherein when the user selects one or more unit images in the album to edit the group tag information, if the edited group tag information already exists, the selected unit images are folded and accommodated into the existing main album collection corresponding to the existing group tag information.

6. The method according to claim 1, wherein when the user needs to locate images with a specific tag, unit images associated with the tag are determined through a search based on the tag information, comprising:
extracting all tag information and positional information of the corresponding tag regions, and establishing an index database based on the extracted information;
performing data matching in the index database based on input search feature information to identify matched tag information; and
determining, based on the positional information of the tag regions corresponding to the matched tag information, the main album collections and/or unit images that are overlapped by and associated with the matched tag information.

7. The method according to claim 1, wherein one or more unit images within the same main album collection are selected, and through a preset interactive operation, the selected unit images are aggregated to create a sub-group, such that the unit images of the sub-group are folded and arranged in an orderly manner to form a sub-album collection in an expanded view of the main album collection.

8. The method according to claim 7, wherein, in the expanded view of the main album collection, the tag floating layer, based on the image layout of the thumbnail window, forms sub-tag regions that overlap and are associated one-to-one with respective sub-album collections at their overlapping regions; wherein the user selects any sub-group in the expanded view of the main album collection and edits sub-tag information, and the edited sub-tag information is correspondingly associated with and displayed in a floating manner within the sub-tag region corresponding to the sub-album collection.
